(19) United States
(12) Patent Application Publication
(10) Pub. No.: US 2006/0256937 A1
(43) Pub. Date: Nov. 16, 2006

(54) System and method for conversation analysis

(76) Inventors: Paul Evan Foreman, Austin, TX (US); David Perry Greene, Austin, TX (US); Philip E. Light, Austin, TX (US); Razvan Loghin, Austin, TX (US); Anand Srinivasan, Arlington Heights, IL (US)

Correspondence Address: IBM CORP. (WIP);c/o WALDER INTELLECTUAL PROPERTY LAW, P.C., P.O. BOX 832745, RICHARDSON, TX, 75083, US

(21) Appl. No.: 11/127,847

(22) Filed: May 12, 2005

(51) Int. Cl. H04M 1/64

(52) U.S. Cl. 379/88.08

(57) ABSTRACT

A method for discovering relationships among elements of a transactional conversation includes tagging a transcribed representation of the conversation to identify elements of the conversation and structuring the tagged conversation according to a specified format to produce a structured, tagged representation of the conversation. A set of structured, tagged conversation representations is then analyzed to discover a relationship between a first conversation element and a second conversation element. Tagging the conversation may include evaluating a portion of the conversation, assigning the portion a message type, and assigning a data value to an attribute defined by the message type. The message type may be defined by a conversation policy, wherein the conversation policy identifies conversation elements including conversation states and message types that transition the conversation among the conversation states. The conversation states include an offer pending state, an offer accept state, and an offer declined state.

### BACKGROUND

1. Field of the Present Invention

The present invention is in the field of data processing and, more particularly, analyzing business communications or conversations to discover useful characteristics of those conversations.

2. History of Related Art

The concept of multiple agents (whether human agents or machine agents) interacting by delivering messages to each other is described in U.S. patent application entitled Apparatus and Method for Providing Modular Conversation Policies for Agents, Publication No. US 2003/0204405 A1 (referred to hereinafter as the Conversation Policy Application). A set of messages having one or more common characteristics or objectives is referred to herein as a conversation. In the context of business applications, many types of conversations may be described or characterized by a conversation policy as discussed in the Conversation Policy Application.

A conversation policy recognizes common characteristics of specific types of conversations. In a generic buyer/seller conversation, for example, a conversation policy might identify certain message types (A makes offers to B, B counters to A, et cetera.) and certain states (offer pending, offer accepted, conversation terminated) that define the corresponding conversation type. A conversation policy thus provides a framework for characterizing the structure of the corresponding conversation type.

Conversation policies are useful to facilitate analysis of a conversation and, more specifically, characteristics of the conversation that influence one or more outcomes of the conversation. In a business setting, an example of a conversation outcome is whether the conversation resulted in a sale. Developing a conversation policy is a useful step in an effort to provide a method and system for analyzing conversations. However, it is still necessary to develop a method for applying a conversation policy to a particular conversation. While a set of conversations may share certain identifiable characteristics, individual instances of conversations frequently do not conform to a specific structure in terms of duration, sequence, content, et cetera. Imagine an example where a buyer (A) is shopping for a new car and engages in a series of conversations with a seller (B). While the conversations are also likely to have common elements (offers, counter offers, and so forth), each specific conversation between A and B is unique. One conversation might, for example, quickly transition to a discussion of the terms of a possible agreement (sale) while another conversation might include a great deal of preliminary discussion such as discussion about the features of the car in question. This uniqueness makes it difficult to apply a conversation policy to any particular instance of a conversation.

It would be desirable to implement a method and system that facilitated the application of conversation policies to actual conversations. It would be further desirable to implement a method and system for using conversation policies to extract useful information from a set of conversation instances such as information indicative of parameters that affect the outcome(s) of a conversation.

### SUMMARY

The identified objectives are addressed by a method for discovering relationships among elements of a transactional conversation. The method includes tagging a transcription of a conversation to identify elements of the conversation and structuring the tagged conversation according to a specified format to produce a structured, tagged representation of the conversation. A set of structured, tagged conversation representations is then analyzed to discover a relationship between a first conversation element and a second conversation element. Tagging the conversation may include evaluating a sentence or other portion of the conversation and assigning a message type to it. Tagging may also include assigning a data value to an attribute associated with the message type. The message type may be defined by a conversation policy, wherein the conversation policy identifies conversation elements including conversation states and message types that transition the conversation among the conversation states. The conversation states include an offer pending state, an offer accept state, and an offer declined state. Structuring the tagged conversation may include incorporating sequence information in the tagged, structured conversation representation, where the sequence information permits reconstruction of a chronological order of the conversation. Structuring the tagged conversation may include converting a tagged conversation into a standardized set of conversation elements suitable for storage in a flat file database. Structuring the tagged conversation may include extracting a first element directly from the tagged conversation and deriving a second element from the tagged conversation. Analyzing the set of structured, tagged conversations may include determining an element associated with conversations determined to be successful. The conversation elements determined to be most associated with successful conversations may be displayed, for example, as a state diagram indicative of the elements or structure of a successful conversation.

### BRIEF DESCRIPTION OF THE DRAWINGS

Other objects and advantages of the invention will become apparent upon reading the following detailed description and upon reference to the accompanying drawings in which:

FIG. 1 is a conceptual representation of a conversation policy suitable for a corresponding type of conversation;

FIG. 2 is a flow diagram of a method of extracting information from a representation of a transactional conversation;

FIG. 3 illustrates an exemplary table into which elements of a conversation are stored following tagging and structuring according to one embodiment of the invention;

FIG. 4 is an exemplary display screen depicting the elements and structure of a successful conversation in state diagram format;

FIG. 5 is a block diagram of selected elements of a data processing system suitable for implementing the present invention;

FIG. 6 is a block diagram of selected elements of a tagging module of FIG. 2; and

FIG. 7 is a conceptual illustration of a tagged conversation produced by the tagging module of FIG. 2.

While the invention is susceptible to various modifications and alternative forms, specific embodiments thereof are shown by way of example in the drawings and will herein be described in detail. It should be understood, however, that the drawings and detailed description presented herein are not intended to limit the invention to the particular embodiment disclosed, but on the contrary, the intention is to cover all modifications, equivalents, and alternatives falling within the spirit and scope of the present invention as defined by the appended claims.

### DETAILED DESCRIPTION OF THE PREFERRED EMBODIMENT

The preferred embodiment encompasses a system and method capable of analyzing transactional conversations to distinguish “good” or “successful” conversations from others conversations. The preferred embodiment achieves this objective by discovering relationships among conversation elements. Conversation elements include the various conversation states that a conversation may achieve and message types that cause conversation state transitions.

The system and method may, for example, determine conversation element(s) having the most significant bearing on the ultimate outcome of the conversation. The preferred embodiment achieves this functionality by tagging and structuring a transcription of a conversation according to a conversation policy. The conversation policy describes the conversation elements applicable to a particular conversation type. The interesting elements of a conversation between a buyer and seller of a good, for instance, might be documented in a conversation policy.

Conversation tagging identifies elements of a conversation instance using a vocabulary defined by the conversation policy. Structuring of tagged conversations refers to using the tags and the conversation policy to extract a common set of conversation elements from each instance of a conversation. Analysis of the structured conversation set identifies factors that influence the outcome of the conversation. The system then displays the results of this analysis to a user.

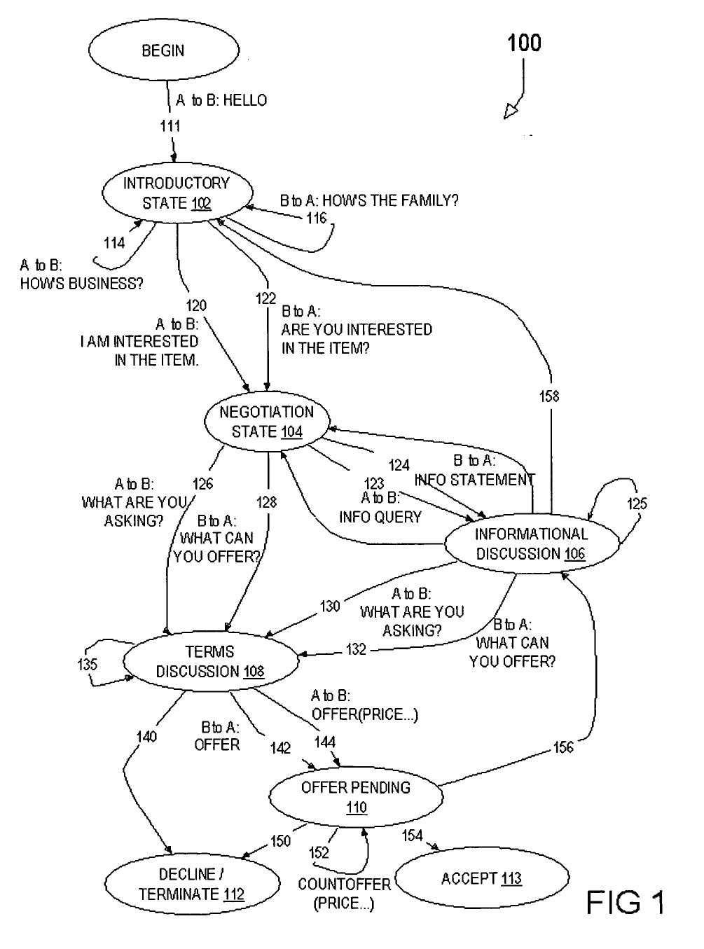

Referring now to FIG. 1, a block diagram representation of an exemplary conversation policy 100 is presented. The preferred embodiment is primarily directed towards the analysis of transactional conversations. For purposes of this disclosure, a transactional conversation may be broadly defined as an exchange of at least one message between two or more people (or other types of agents) for the purpose of making a decision and especially an economic decision such as a decision regarding the purchase or sale of a good or service.

Within this broad class of conversations, it is highly desirable to understand relationships and correlations among the conversation elements. In particular, understanding the elements that most directly influence the outcome of the conversation can provide valuable information for training and other purposes. Unfortunately, conversations are unlikely to originate in a structured format suitable for analysis by conventional analysis tools and this is especially true for conversations among human agents. The conversation polices provided by the Conversation Policy Application provide a starting point for the process of extracting useful information from a set of unstructured conversations. The preferred embodiment provides a system and method for applying the structure inherent in a conversation policy to actual conversations to discover causal relationships among conversation elements.

Transactional conversation policy 100 as depicted in FIG. 1 represents a corresponding conversation type as including a set of conversation states and a set of exchanged conversation messages. Each element shown in conversation policy 100 is included in the policy because the element is typically present in actual conversations, the element is thought to be of interest for purposes of determining the outcome of the conversation, or both.

The depicted embodiment of conversation policy 100 includes conversation states such as an introductory state 102, a negotiation state 104, an informational discussion state 106, a term discussion state 108, an offer pending state 110, a decline/terminate state 112, and an offer accepted state 113. Messages represented by reference numerals 114 through 158 are exchanged between conversation agents A and B. Messages 114 through 158 may cause transitions from one of the conversation states to another. Moreover, each message may include data values (not shown) corresponding to attributes of the message. For example, a message from Agent A to Agent B offering to buy an item may include a price (data value) corresponding to a price attribute and may also include one or more terms attributes and corresponding values.

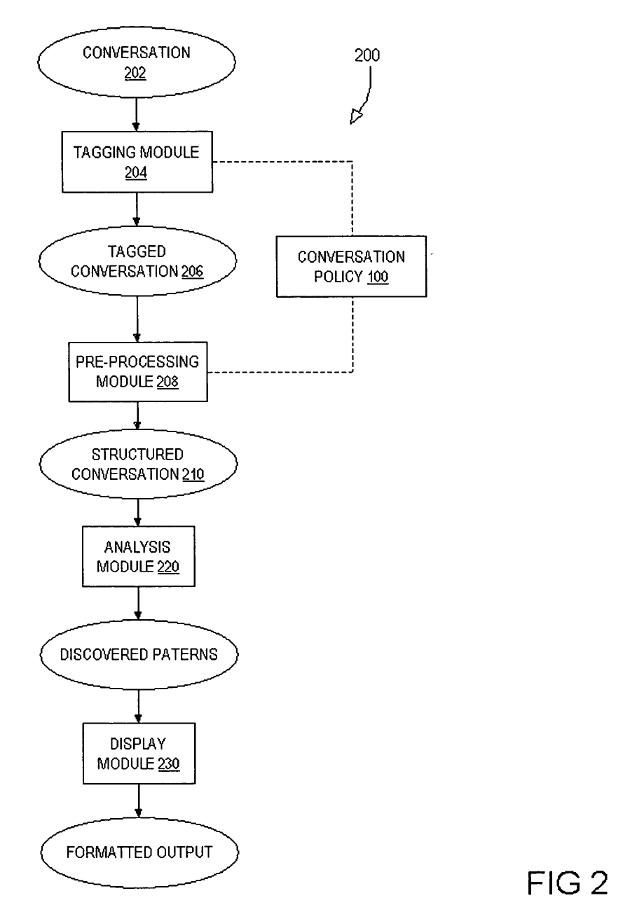

The introductory state 102 represents a conversation state in which Agent A and Agent B are exchanging introductory messages. An introductory message is a message that does not include or pertain to specific terms of a proposed transaction. For example, a conversation may initially transition to introductory state 102 when Agent A (who is the buyer in this illustration) introduces himself to Agent B (the seller) in message 111. The conversation may then remain in introductory state 102 while Agent A and Agent B exchange introductory messages (represented by reference numerals 114 and 116). Identifying introductory messages in a conversation and distinguishing such messages from other messages is achieved using natural language processing tools as discussed below with respect to FIG. 2.

While the introductory state 102 and the corresponding messages 114 and 116 may not appear to be directly relevant to the ultimate outcome of the transactional conversation, they may be included as elements in conversation policy to determine whether the number and/or content of these introductory messages does in fact have a bearing on the outcome.

The representation of conversation policy 100 as a state diagram provides insight into the structure of those conversations to which conversation policy 100 applies, but the state diagram view is not ideal for conveying the chronologically sequential order of a particular instance of a conversation. Thus, with reference to introductory state 102, for example, the agents may exchange any number of introductory messages before transitioning to another state of the conversation. To capture this chronology, sequence information may be included as part of a structured representation (described below) of a particular instance of a conversation. This sequence information would preferably permit the reconstruction of the chronological order of a conversation from the structured representation.

According to the conversation policy 100 depicted in FIG. 1, a conversation transitions from introductory state 102 to a negotiation state 104 when one of the agents issues or sends a probing message such as a message from A to B (message 120) indicating A's interest in an item or a message from B to A (message 122) inquiring about A's interest in an item. In certain instances of a conversation, the participants may skip introductory state 102 entirely and transition directly to a negotiation state, although the depicted conversation policy 100 assumes at least a minimal transition through introductory state 102.

Once in the negotiation state 102, a conversation may transition to an information discussion state 106 or a terms discussion state 108. A conversation transitions to information discussion state 106 when B sends an informational statement (message 124) or A asks an informational question (message 123). Informational state 106 reflects the quantity and content of messages exchanged between the agents regarding factors or characteristics of a proposed transaction that are not directly about the terms of the transaction. Informational discussion 106 may include, for example, discussions about features of a product for sale and especially features that may be standard or otherwise non-negotiable. Agent B may, in an attempt to persuade Agent A of the value of a particular item, discuss the features or characteristics of the item that are included in an item. The discussion policy 100 recognizes that the conversation may transition between negotiation state 104 and information discussion state 106 indefinitely as the agents exchange informational queries and responses. Conversation policy 100 also recognizes that a conversation may transition from information discussion state 106 back to introductory state 102 (in which the agents are not discussing an item or good at all) such as might occur when either or both of the agents suspect an impasse in the discussions.

Conversation policy 100 indicates a terms discussion state 108 to which a conversation may transition directly from negotiation state 104 or from informational state 106. Terms discussion state 108 reflects the messages exchanged between the agents regarding the precise terms of a proposed deal, transaction, or agreement.

A transition from negotiation state 104 occurs when either agent issues a term-probing message, exemplified in FIG. 1 by messages 126 and 128. A term-probing message refers to a message that brings the price of an item into the conversation. A similar transition can occur directly from an informational discussion state 106, as represented by messages 130 and 132. Although the depicted example highlights price as a term that is discussed in the terms discussion state 108, other terms such as time for completion or delivery, warranty or support terms, optional features of the negotiated item or service, financing, and so forth are also equally applicable to terms discussion state 108.

From terms discussion state 108, conversation policy 100 includes paths to an offer pending state 110 through a message 144 in which A makes an offer on stated terms (price, quantity, time terms, et cetera) or a message 142 in which B offers to sell an article on stated terms. The offer messages, as represented in conversation policy 100, are messages that include data values corresponding to attributes of the message. As an example, messages 142 and 144 include a data value corresponding to a price attribute of the message.

Various transitions from offer pending state 110 are indicated by a message 150, in which the offer is declined and the negotiation terminated (state 112), a message 154, in which a pending offer is accepted (state 113), and a message 156, in which the conversation reverts back to informational discussion state 106. Message 152, in which a counter offer is made, results in a return to offer pending state 110. A transition directly from terms discussion state 108 to decline and terminate state 112 via message 140 represents a conversation in which the conversation terminates before a firm offer is made or received by either party.

Thus, conversation policy 100 provides a structured representation of a corresponding type of conversation. Any instance of a conversation itself may manifest itself with any or all of the messages and state transitions indicated by the conversation policy. In this manner, the conversation policy 100 extracts a formalized set of states, messages, and message data values from various conversations.

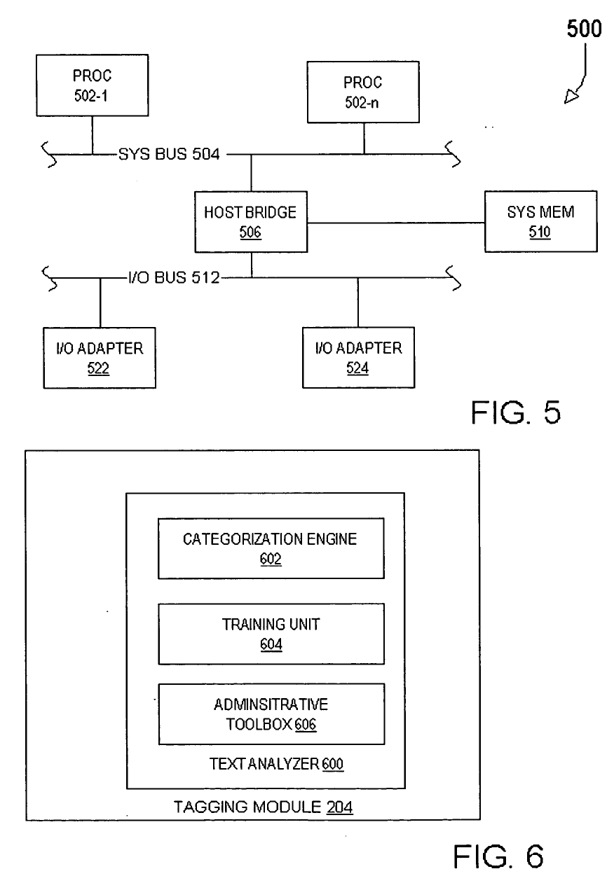

Referring now to FIG. 5, a block diagram of selected elements of a data processing system 500 that may implement an embodiment of the invention is shown. In the depicted embodiment, system 500 includes one or more general-purpose processors 502-1 through 502-n (generically or collectively referred to as processor(s) 502). Processors 502 are each connected to a shared system bus 504. Processors 502 may be implemented with various commercially distributed microprocessors including the PowerPC® family of processors from IBM Corporation or an x86-type processor.

Processors 502 share access to a system memory 510 that is connected to system bus 504 through an intervening host bridge 506. Host bridge 506 also connects system bus 504 to an I/O bus (also referred to as a peripheral bus) 512. Whereas system bus 504 is likely implemented according to a proprietary protocol, I/O bus 512 is preferably implemented with an industry standard protocol such as the PCI (Peripheral Components Interface) or the PCI-X protocols. I/O adapters 522 and 524 connect to I/O bus 512 and provide an interface between peripheral devices (not shown) and processors 502. I/O adapters 522 and 524 may include one or more of the following types of adapters: hard disk controllers, graphics adapters, network interface adapters, audio adapters, and so forth.

Referring now to FIG. 2, a flow diagram of a method and system 200 for analyzing conversations according to one embodiment of a preferred embodiment is illustrated. Portions of system 200 may be implemented as a sequence or set of computer executable instructions (computer software code) that, when executed by a data processing system such as data processing system 500 of FIG. 5, perform the steps of the depicted method. In computer software code embodiments, the code is likely stored on a persistent, computer readable storage medium such as a hard disk, a floppy diskette, a CD ROM, and the like. During periods when the code is executing, the code may be stored on a volatile medium such as system memory 510 or a cache memory (not depicted) of processor 502.

In the depicted implementation, the method and system 200 includes four stages of processing required to extract useful information from one or more conversations. The depicted implementation begins with a conversation 202. In the preferred embodiment, conversation 202 refers to an electronic representation of an interaction dialog between or among two or more agents. The manner in which a conversation is represented electronically is implementation specific. Some conversations, such as email or other computer-based conversations, originate in an electronic form that is suitable for processing, with little or no modification, by method and system 200. Oral conversations may be transformed to an electronic representation through automated or manual transcription tools and techniques. An example of an automated transcription tool suitable for such a purpose is the Transcription Portlet from IBM Corporation that facilitates the transcription of telephony-based communication.

Initially, system 200 applies a tagging module 204 to transcribed conversation 202 to assign tags to all or parts of conversation 202. In one implementation, the tags applied by tagging module 204 identify elements of conversation 202 that are defined by a conversation policy 100 (see FIG. 1). Using conversation policy 100 of FIG. 1 as an exemplary conversation policy, tagging of a conversation 202 may include evaluating a portion of conversation 202 (e.g., a sentence) and identifying the portion or sentence as one of the messages included in conversation policy 100. If, for example, the conversation 202 includes a first sentence in which Agent B states: “Hello, A, how have you been?”, tagging module 204 according to one embodiment of the invention will identify this sentence as a message 116, corresponding to the introductory statement 116 from B to A shown in conversation policy 100 of FIG. 1. Tagging module 204 may also identify and tag other parts of conversation 202 including the identities of the agents and any specific contract terms under discussion.

Tagging module 204 achieves the described functionality using existing natural language processing (NLP) tools, text mining tools, semantic analysis tools, and other related technologies. Included in these NLP tools are conversational dialog systems and text analyzers from IBM Corporation. Conversation dialog systems create universal and application specific dialog engines for managing conversation histories and parsing information from conversation dialogs. Such systems are capable of facilitating analysis of a wide variety of business conversations from stock trading to product information systems. Tagging module 204 may include a text analyzer including features or components found in the IBM Text Analyzer Business Component of the IBM WebSphere product.

Referring to FIG. 6, an embodiment of tagging module 204 is depicted to emphasize its text analyzer features. In this embodiment, tagging module 204 includes a text analyzer 600 suitable for automating the analysis of large volumes of free form text messages. Text analyzer 600 includes a categorization engine 602, a training unit 604, and an administrative toolbox 606.

Tagging module 204 receives conversation 202 and provides conversation 202 to text categorization engine 602. Categorization engine 602 analyzes conversation 202 using a set of user-defined rules (not shown) to tag sentences or portions of conversation 202 according to the messages included in conversation policy 100. Training unit 604 and administrative toolbox 608 assist the user in developing, editing, and testing the rule set used by categorization engine 602. Software code suitable for implementing an embodiment of text analyzer 600 is available from IBM Corporation.

Tagging module 204 applies the text analysis functionality to the conversational analysis of the preferred embodiment by implementing text analyzer 600 in conjunction with a specific conversation policy 100. More specifically, tagging module 204 leverages conversation policy 100 to refine the analysis of the grammatical and syntactical structure of conversation 202. By associating the training unit 604 of text analyzer 600 with a specific conversation policy 100, the rule set used by categorization engine 602 is customized to analyze the conversations of interest. Sentences and other conversation portions are analyzed by tagging module 204 in the context of a predetermined and finite set of message types (taken from the conversation policy). In this manner, tagging module 204 extends the conventional functionality of text analysis tools to assign tags that are relevant and specific to conversation policy 100.

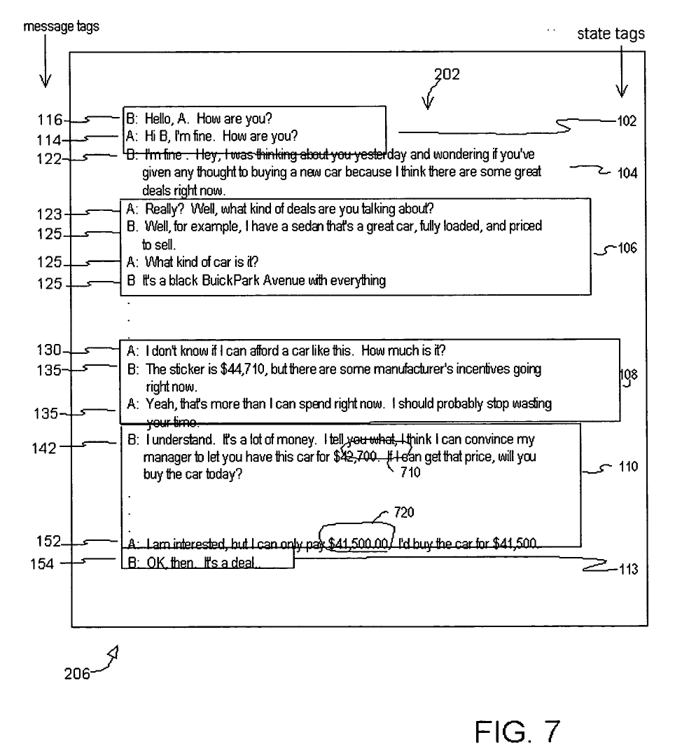

The output of tagging module 204 is a tagged conversation 206. A conceptual representation of a portion of an exemplary tagged conversation 206 is depicted in FIG. 7. Tagged conversation 206 contains the same textual content as the corresponding conversation 202, but includes tags that identify elements (e.g., messages and conversation states) of conversation 202 according to a conversation policy 100. Tagged conversation 206 as depicted in FIG. 7 includes state tags 102-113 and message tags 116-154. Tagging module 204 applies message tags 116-154 to sentences (or other portions) of the conversation based on conversation policy 100. As an example, conversation policy 100 (see FIG. 1) includes a message 116 representing an introductory comment made by Agent B to Agent A. Tagging module 204, using natural language processing tools including the text analyzer described above, determines that the statement “Hello. How are you?” by Agent B represents an introductory message from Agent B to Agent A. Tagging module 204, which has access to conversation policy 100, tags the statement as a message 116 indicating that, like the message 116 of conversation policy 100 depicted in FIG. 1, the statement of B illustrated in FIG. 7 functions as an introductory message from B to A.

Tagging module 204 thus assigns message tag values to sentences or other portions of a conversation 202. In addition, tagging module 204 assigns conversation state tags 102-113 to portions of conversation 202. The conversation states identified by tagging module 204 correspond to conversation states defined in conversation policy 100.

In addition to message and conversation states, tagged conversation 206 as shown in FIG. 7 includes data values 710 and 720. Some messages, such as an offer message 142 and a counter offer message 152, include data values that indicate a value for an attribute of the message. Offer and counter offer messages 142 and 152, for example, include a price attribute indicative of the price term in an offer or counter offer. (Conversation policy 100 as depicted in FIG. 1 conveys messages having attributes with a parenthetical expression identifying the attribute).

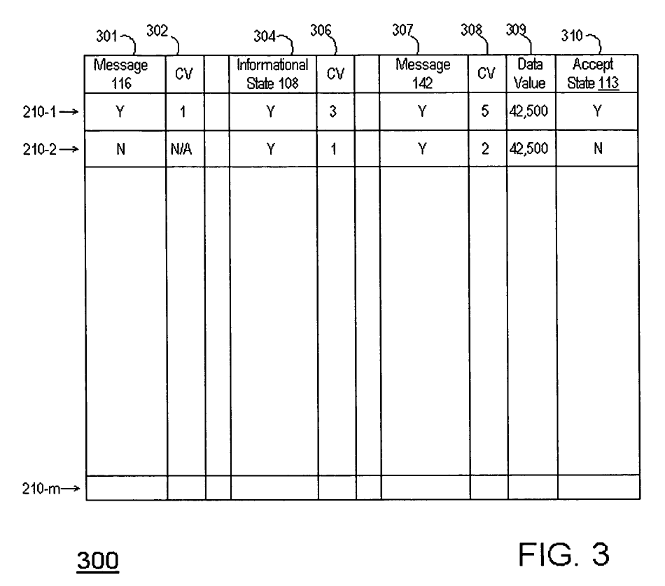

Returning to FIG. 2, a preprocessing module 208 then acts on tagged conversation 206 to produce a structured conversation 210. Structured conversation 210 is a representation of tagged conversation 206 that complies with a user-defined standard. Whereas each tagged conversation 206 may be unique in its content, length, ordering of statements, and so forth, each structured conversation 210 shares a common structure, an example of which is described below with respect to FIG. 3. Generating two or more structured conversations from their respective tagged conversations facilitates the analysis of multiple conversations by, among other things, enabling the use of conventional analysis tools. As an example, a conventional spreadsheet application may be sufficient to perform the desired analysis of multiple conversations after the conversations have been structured to a common format.

In the preferred embodiment, the preprocessing module 208 generates a structured conversation 210 corresponding to each tagged conversation 206. Each structured conversation 210 includes a common set of conversation elements (messages, conversation states, data values, et cetera). Each structured conversation 210 is suitable for storing as a record in a “flat file” database such as the flat file database 300 depicted in FIG. 3. A flat file database is a database in which each record in the database is presented in a single table. In flat file database 300, each structured conversation 210 represents a record (row) in database 300. Thus, database 300 of FIG. 3 emphasizes an important benefit of using processing module 208 to generate structured conversations 210, namely, comparative analysis of a two or more conversations is easier to achieve when the conversations have a common structure.

In the implementation depicted by database 300, structured conversations 210 generated by preprocessing module 208 have at least some columns that correspond to conversation elements such as messages, conversation states, and data values defined by conversation policy 100. Each structured conversation 210 represented in FIG. 3, for example, includes a column 301 indicative of whether the corresponding tagged conversation 206 contained a message 116 tag. In other words, column 301 of table 300 indicates whether the corresponding conversation included an introductory statement from Agent B to Agent A. Similarly, table 300 includes a column 304 indicative of whether a conversation reached informational discussion state 108, a column 307 indicative of whether a conversation included an offer message 142, and a column 310 indicative of whether the conversation reached an accepted offer state 113.

Preprocessing module 208 may generate structured conversations indicative of the absence or presence of every conversation element in conversation policy 100. Alternatively, preprocessing module 208 may generate structured conversations 210 that included indications of only selected conversation elements. Moreover, although the depicted implementation of structured conversations 210 merely indicates the absence or presence of the corresponding conversation elements, other implementations of structured conversations 210 may also include the content of any conversation element 301-310 that is present.

Structured conversations 210 generated by preprocessing module 208 may also include information indicative of the sequential or chronological ordering of conversation elements. In the implementation depicted in FIG. 3, for example, each structured conversation 210 includes a column 302 containing a chronological value (CV) that is applicable to the message 116 indicated in column 301. A CV is preferably an integer value that conveys the relative ordering of conversation elements in structured conversation 210. A CV of 1, for example, indicates that the corresponding conversation element occurred before any of the other conversation elements. The CV data is valuable to convey a chronology of the corresponding conversation while still enabling the creation of structured conversations. Structured conversations 210 as depicted in FIG. 3 include CV data (columns 302, 306, and 308) for each conversation element (columns 301, 304, and 307 respectively).

The depicted implementation of structured conversations 210 of FIG. 3 further include at least one data value corresponding to conversation elements that are associated with data values. As discussed previously, some conversation elements such as offer messages 142 and counteroffer messages 152 are associated with one or more data values (the price of the offer or counteroffer, for example). If any of these messages are reflected in structured conversation 210, the structured conversation may also include a data value indicator. As depicted in FIG. 3, structured messages 210 include a column 309 containing a data value corresponding to the message 142 (an offer message) indicated in column 307.

As is apparent from the structure of database 300, each structured conversation 210 includes a common number of elements, which an analysis module may compare, sort, or otherwise manipulate. Reduction of unstructured tagged conversations 206 to a defined, structured format is the function of preprocessing module 208 that enables a subsequent analysis engine to operate on a set or plurality of conversations.

The number and type of elements that processing module 208 may generate is limited only by storage and processing constraints. Moreover, conversation policy 100 can vary from a highly complex representation of the underlying conversation to a generic representation of only the most significant features of the conversation. Ultimately, however, each structured conversation 210 produced by preprocessing module 208 includes a common set of elements regardless of the size and structure of the underlying conversation. In this manner, method and system 200 operates independently of the length and structure of the underlying conversation. System 200 is equally applicable to highly structured, fixed length conversations and variable-length conversations.

Returning to FIG. 2, the structured conversations 210 produced by preprocessing module 208 are analyzed with an analysis module 220. Analysis module 220 searches the database 300 (FIG. 3) for relationships between the conversation elements and other data represented in columns 301 through 310. Analysis module 220 preferably identifies the conversation elements that are most relevant in distinguishing conversations based on selected conversation characteristics. As an example, the structured conversations 210 in database 300 include a column 310 indicative of whether the corresponding conversation reach an accept state (conversation state 113 in FIG. 1). In this case, analysis module 220 is preferably configured to identify factors that are predictive of successful conversations (those conversations that concluded with conversation state 113). Illustrating the analysis contemplated by analysis module 220 with respect to the two structured conversations 210-1 and 210-2 represented in FIG. 3, analysis module 220 might conclude, based on structured conversations 210-1 and 210-2 and more specifically, the data contained in columns 309 and 310 that the successful outcome of a conversation (column 310) is not significantly influenced by the price at which an item is initially offered to the buyer by the seller (column 309). Similarly, analysis module 220 might conclude from columns 301 and 310 that the absence or presence of introductory messages from the seller to the buyer (column 301) is predictive of the conversation's outcome (column 310). Analysis module 220 employs a number of known analysis techniques including, as examples, regression analysis, principal components analysis, factor analysis, and so forth.

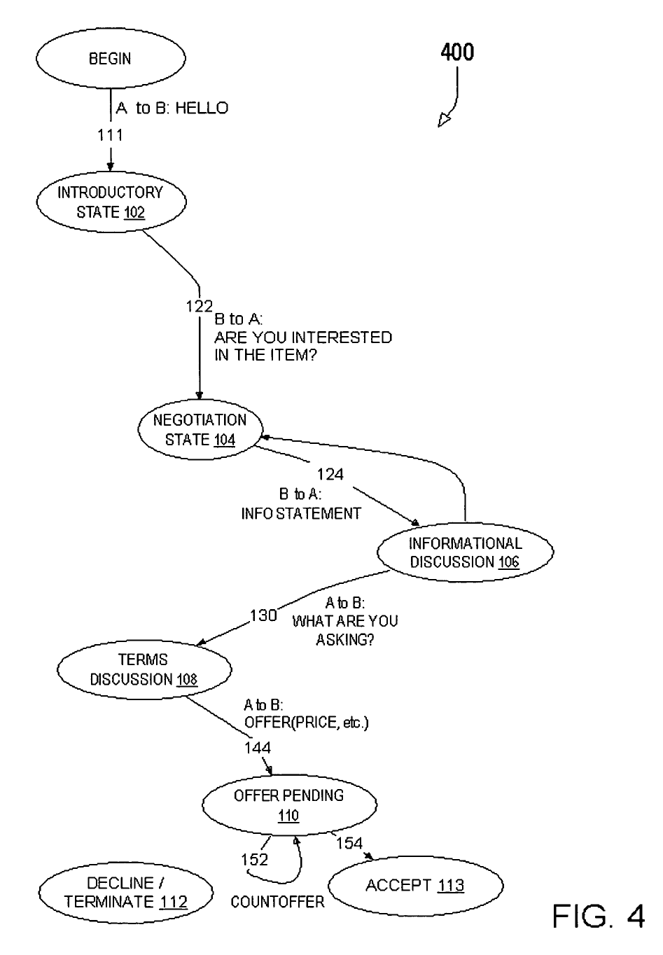

An embodiment of system 200 may produce a graphical visualization of information contained in or derived from database 300 of structured conversations 210. Referring to FIG. 4, exemplary graphic 400 is a graphical representation of a pattern in database 300 discovered by analysis module 220. The depicted example of graphic 400 is a representation of a hypothetical conversation that is most likely to reach a particular result, namely, achieving the accept state 113. Analysis module 220 is configured to process data stored in database 300 to identify the conversation elements having the strongest correlation to a result of interest.

Having identified the conversation elements that correlate to achieving the accept state 113, a display module 230 (FIG. 2) constructs a graphical image of the hypothetical conversation discovered by analysis module 220. In the depicted example, graphic 400 is in a state diagram form analogous to the state diagram depiction of conversation policy 100 in FIG. 1. However, because analysis module 220 identifies only some of the conversation elements of conversation policy 100 as having a significant impact on a successful result, the state diagram graphic 400 of FIG. 4 appears as a simplified revision of conversation policy 100. Graphic 400 is useful in conveying a great deal of information about the elements of a successful conversation. As an example, the depicted example of graphic 400 conveys that the transition from an introductory state 102 to a negotiation state 104 most likely occurs when Agent B (seller) sends a message 122 asking Agent A if he has an interest in an item for sale. This information might be used in seminars to train prospective salesman to initiate probing questions, such as message 122 in FIG. 4, rather than waiting for Agent B to transition the conversation to a negotiation state. Graphic 400 further depicts a successful conversation as one in which Agent A transitions the conversation from information discussion state 106 to a terms discussion state 108. A sales organization might use this information to train its sales force to let the customer initiate the discussion of specific terms.

In this manner, graphic 400 illustrates the conversation elements most frequently associated with successful conversations. Graphic 400 conveys the basic structure of successfully concluded conversations. In the specific example depicted, the user sees that a successful conversation typically requires or involves the seller actively “moving” the conversation from state 102 to 104 to 106, but then permitting the buyer A to transition the discussion from state 106 to the terms discussion state 108 and make the initial offer (message 144).

In the foregoing description, a significant aspect of the preferred embodiment is the leveraging of existing tools to perform some or all of the component steps of the analysis process while combining the tools, together with the conversation policy concept, to facilitate analysis of conversation instances. It will be apparent to those skilled in the art having the benefit of this disclosure that the preferred embodiment contemplates a system and method for analyzing conversations. It is understood that the form of the invention shown and described in the detailed description and the drawings are to be taken merely as presently preferred examples. It is intended that the following claims be interpreted broadly to embrace all the variations of the preferred embodiments disclosed.

What is claimed is:

1. A computer implemented method for processing a plurality of transcribed conversations, comprising:
tagging, by the computer, the conversations using a plurality of conversation element tags including message tags and conversation state tags to identify elements of the conversations including message elements and conversation state elements;
structuring, by the computer, the tagged conversations by applying a common ordering to at least some of the identified conversation elements in the tagged conversations;
analyzing, by the computer, the structured conversations to discover a relationship between at least two of said identified conversation elements.

2. The method of claim 1, wherein the conversation element tags comprise conversation element tags defined by a conversation policy, wherein the conversation policy defines messages and conversation states that are characteristic of the conversations.

3. The method of claim 2, wherein the conversation policy defines messages that transition the conversation state from a first conversation state defined by the conversation state to a second conversation state defined by the conversation policy.

4. The method of claim 3, wherein said tagging comprises evaluating, by a text analyzer, a portion of the conversation and, based on said evaluating, assigning an appropriate message tag to the portion.

5. The method of claim 3, wherein the conversation states include an offer pending state, an offer accept state, and an offer declined state.

6. The method of claim 1, wherein said structuring includes incorporating sequence information in the structured conversations, wherein the sequence information permits reconstruction of a chronological order of at least some of the identified elements of the conversation.

7. The method of claim 1, wherein the structured conversations are suitable for storage as a flat file database.

8. The method of claim 1, wherein one of the at least two identified conversation elements is indicative of an outcome of the corresponding conversation wherein said analyzing comprises discovering a relationship between at least one of the identified conversation elements and an outcome of the conversation.

9. The method of claim 8, further comprising generating, by the computer, a graphical display indicative of the relationship between the identified conversation elements and the conversation outcomes.

10. The method of claim 9, wherein said graphical display comprises a state diagram indicative of a successful conversation.

11. A computer program product comprising computer executable instructions, stored on a computer readable medium, for processing transactional conversations, the program product comprising:
computer code means for tagging the conversations using a plurality of conversation element tags including message tags and conversation state tags to identify elements of the conversations including messages and conversation states;
computer code means for structuring the tagged conversations by applying a common ordering to at least some of the identified conversation elements in the tagged conversations;
computer code means for analyzing the structured conversations to discover a relationship between at least two of said identified conversation elements.

12. The computer program product of claim 11, wherein the messages and converstation states are defined by a conversation policy, and further wherein the conversation policy identifies messages that transition the conversation among the conversation states.

13. The computer program product of claim 11, wherein the computer code means for tagging the conversation includes text analyzer code means for evaluating a portion of the conversation and, based on said evaluating, tagging the portion with a message tag.

14. The computer program product of claim 13; wherein the conversation policy defines data values associated with at least some of the messages and further wherein the computer code means for analyzing the structured conversation includes computer code means for assigning data values to the structured conversation.

15. The computer program product of claim 14, wherein the conversation states include an offer pending state, an offer accept state, and an offer declined state.

16. The computer program product of claim 11 wherein the code means for structuring the tagged conversation includes computer code means for incorporating sequence information in the structured conversations wherein the sequence information permits reconstruction of a chronological order of the identified elements of the conversation.

17. The computer program product of claim 11, wherein the code means for analyzing the structured conversations comprises computer code means for discovering a relationship between at least one of the identified conversation elements and outcomes of the conversations.

18. The computer program product of claim 17, further comprising code means for displaying the relationship between at least one of the identified conversation elements and outcomes of the conversations.

19. A system for analyzing transcribed conversations, comprising:
a tagging module, including a text analyzer, to apply tags to the conversations, wherein the tags identify conversation elements recognized by a conversation policy;
a preprocessing module to produce structured conversations from the tagged conversations, each of the structured conversations sharing a common ordering of conversation elements;
an analysis module to apply to the structured conversations to identify relationships among the conversation elements;
a display module to present a graphical depiction of relationships among the conversation elements.

20. The system of claim 19, wherein the analysis module discovers relationships among at least one of the conversation elements and outcomes of the conversations.
